(19) United States
(12) Patent Application Publication
(10) Pub. No.: US 2018/0231234 A1
(43) Pub. Date: Aug. 16, 2018

(54) MULTI-FUNCTIONAL HEAD LAMPS

(71) Applicant: Aixia Bian, Shanghai (CN)

(72) Inventor: Aixia Bian, Shanghai (CN)

(21) Appl. No.: 15/475,620

(22) Filed: Mar. 31, 2017

Related U.S. Application Data
(60) Provisional application No. 62/457,453, filed on Feb. 10, 2017.

(51) Int. Cl. F21V 33/00; F21L 4/08; F21V 7/00; F21V 17/06; F21V 21/14; F21V 23/04; F21L 4/02; F21L 26/00; A41D 20/00; A41D 1/00

(52) U.S. Cl. CPC F21V 33/0008; F21L 4/08; F21V 7/0075; F21V 17/06; F21V 21/145; A41D 1/002; F21V 23/0442; F21L 4/02; F21L 26/00; A41D 20/00; F21V 23/0414

(57) ABSTRACT

This present invention provides a head lamp comprising a housing; at least one light source affixed to a surface of the housing and operable to emit light; a reflecting unit affixed to the surface of the housing, the reflecting unit comprising a reflector and a fluorescer; a power source operable to power the at least one light source; a bracket releasably coupled to the housing; and a head band connected to the bracket.

### CROSS-REFERENCE TO RELATED APPLICATION

The present application claims priority to U.S. Application No. 62/457,453, filed on Feb. 10, 2017, the contents of which are incorporated here by reference in their entirety.

### BACKGROUND OF THE INVENTION

Advances in technology have enabled lighting devices to become increasingly lightweight and portable. Light emitting diodes (LEDs) are capable of efficiently converting electrical energy into light with little waste heat, allowing them to provide extended illumination with portable energy sources, such as batteries.

While LED head lamps are well known in the art, in some applications it would be desirable to be able to remove the lighting apparatus from the rest of the head lamp. Further, because head lamps are often used in the dark, it would be desirable to include a fluorescent component in the head lamp so that the head lamp may be easily found in the dark when the light is switched off. Thus, there is an identifiable need for a detachable head lamp with a fluorescent component.

### BRIEF DESCRIPTION OF THE DRAWINGS

FIG. 1 is a rear view of a first example head lamp of the present invention.

FIG. 2 is a bottom view of the first example head lamp of FIG. 1.

FIG. 3 is a front view of the first example head lamp of FIG. 1.

FIG. 4 is a front perspective view of the first example head lamp of FIG. 1.

FIG. 5 is another front perspective view of the first example head lamp of FIG. 1.

FIGS. 6A-6B are perspective views of a housing and a bracket of the first example head lamp of FIG. 1.

FIG. 7 is a left side view of the first example head lamp of FIG. 1.

FIG. 8 is a right side view of the first example head lamp of FIG. 1.

FIG. 9 is a top view of the first example head lamp of FIG. 1.

FIG. 10 is a rear view of a second example head lamp of the present invention.

FIG. 11 is a bottom view of the second example head lamp of FIG. 10.

FIG. 12 is a front view of the second example head lamp of FIG. 10.

FIG. 13 is a front perspective view of the second example head lamp of FIG. 10.

FIG. 14 is another front perspective view of the second example head lamp of FIG. 10.

FIGS. 15A-15B are perspective views of a housing and a bracket of the second example head lamp of FIG. 10.

FIG. 16 is a left side view of the second example head lamp of FIG. 10.

FIG. 17 is a right side view of the second example head lamp of FIG. 10.

FIG. 18 is a top view of the second example head lamp of FIG. 10.

### DETAILED DESCRIPTION OF THE INVENTION

The following description of example methods and apparatus is not intended to limit the scope of the description to the precise form or forms detailed herein. Instead it is intended to be illustrative so that others may follow its teachings.

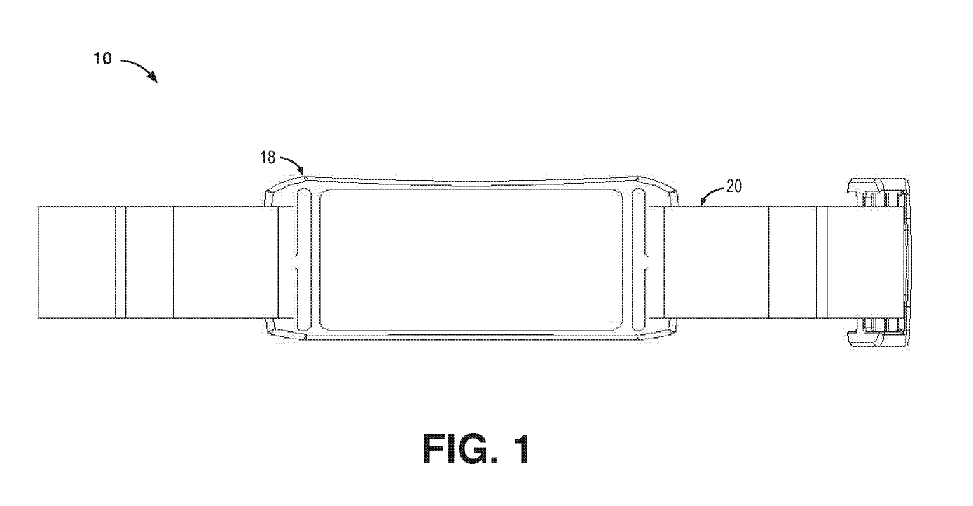

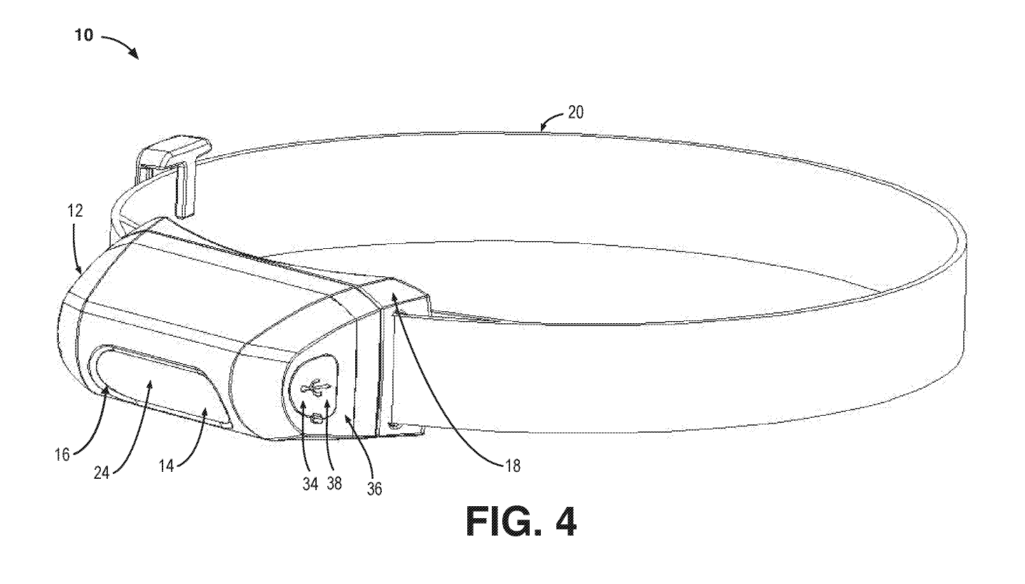

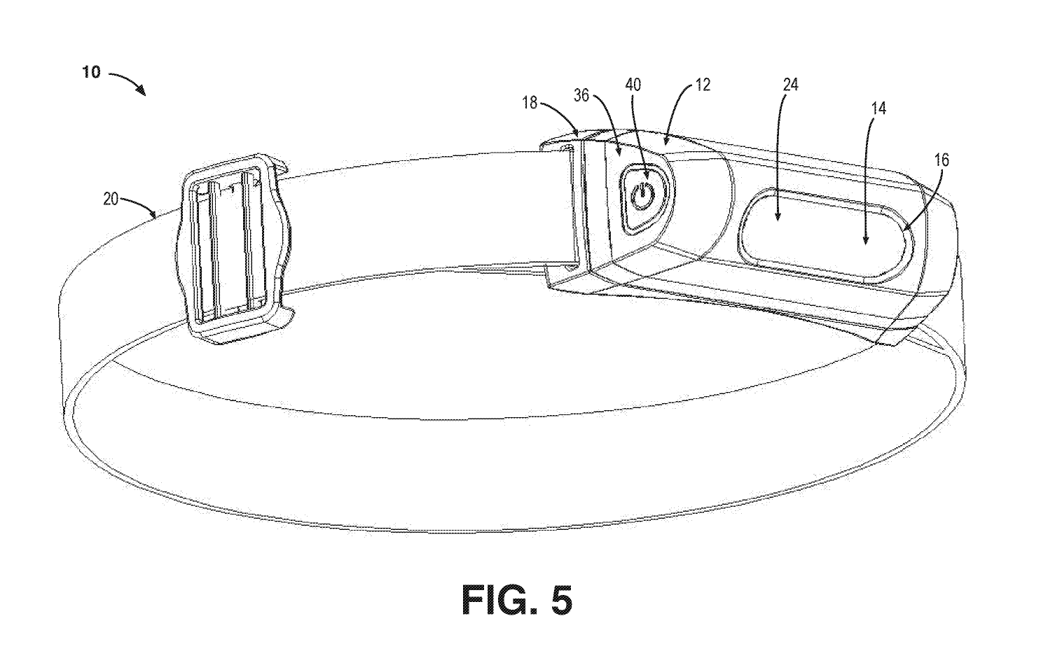

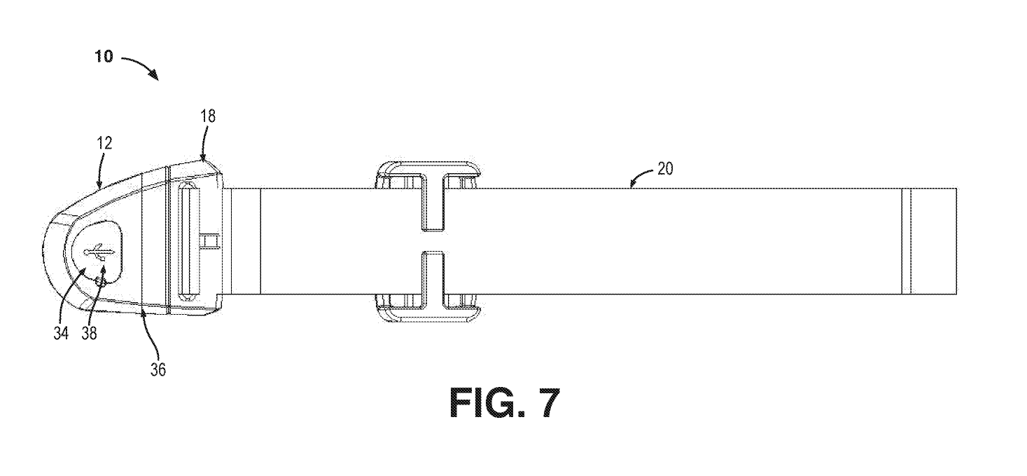

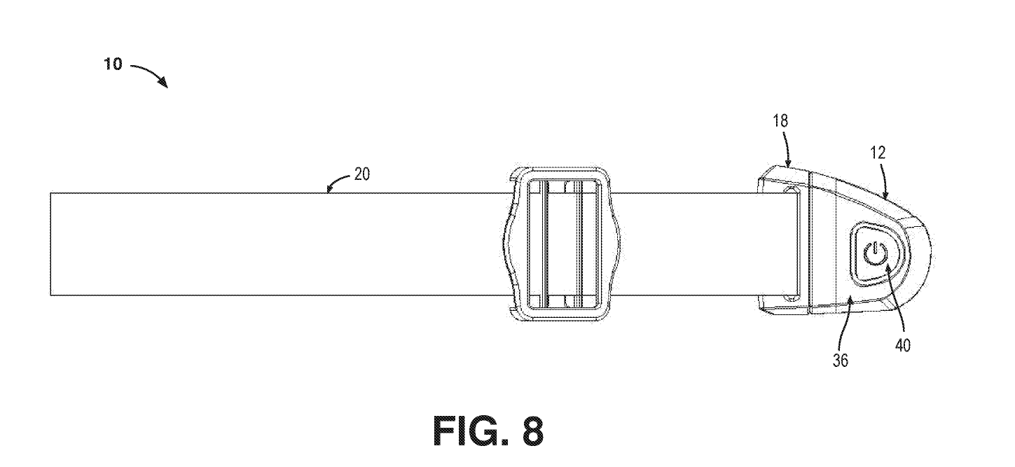

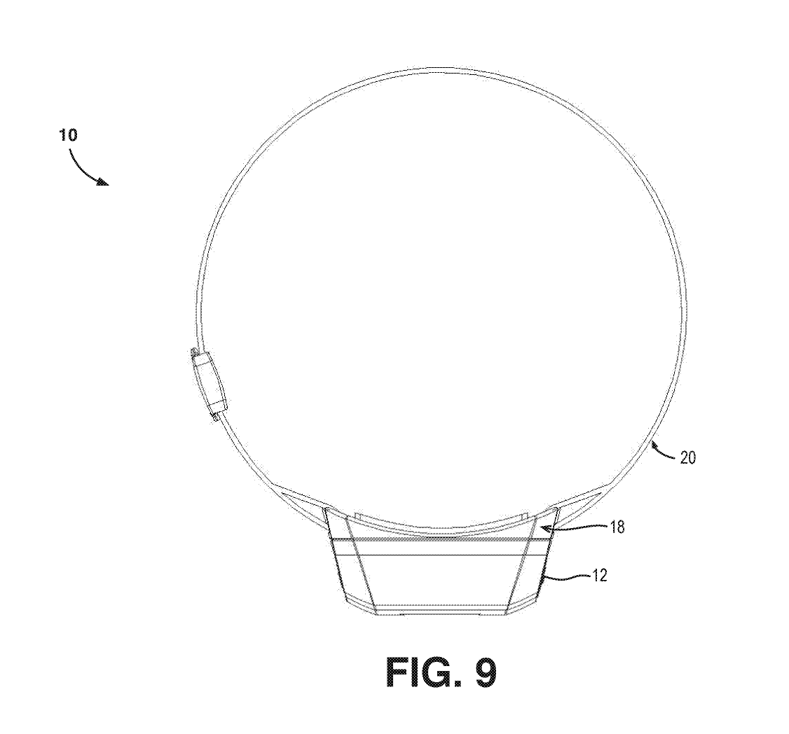

Referring now to FIGS. 1-9, there is illustrated a first example head lamp 10 in accordance with the teachings of the present disclosure. The example head lamp 10 comprises a housing 12, a lighting unit 14 received in an opening 16 of the housing 12, a bracket 18 releasably coupled to the housing 12, and a head band 20 connected to the bracket 18.

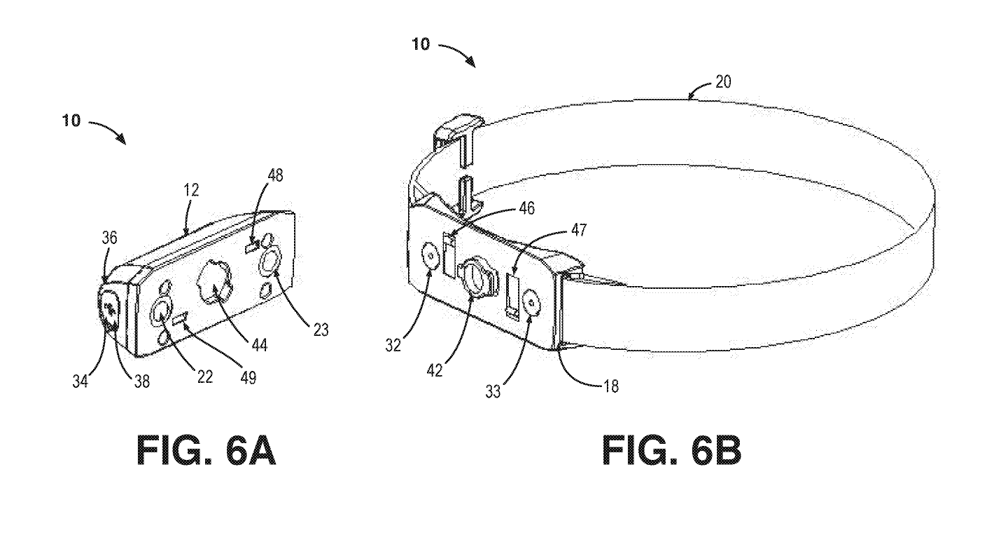

The example head lamp 10 may be configured for both indoor and outdoor uses. Thus, the housing 12 may be formed to provide the head lamp 10 with impact resistance, water resistance, and/or dust resistance. As will be appreciated by one of ordinary skill in the art, the example housing 12 may be formed with any suitable material, such as for instance, aluminum, plastic, carbon fiber, etc. As shown in FIG. 6A, the housing 12 may include a pair of magnets 22, 23, so as to allow the housing 12 to be magnetically coupled to a metal surface, such as the hood of a car. It will be understood that the size, number, and/or location of the pair of magnets 22, 23 may vary as necessary or desired.

The head band 20 is configured to be worn around a user's head. The head band 20 is configured to be adjustable so that the user may adjust the circumference of the head band 20 to fit as desired.

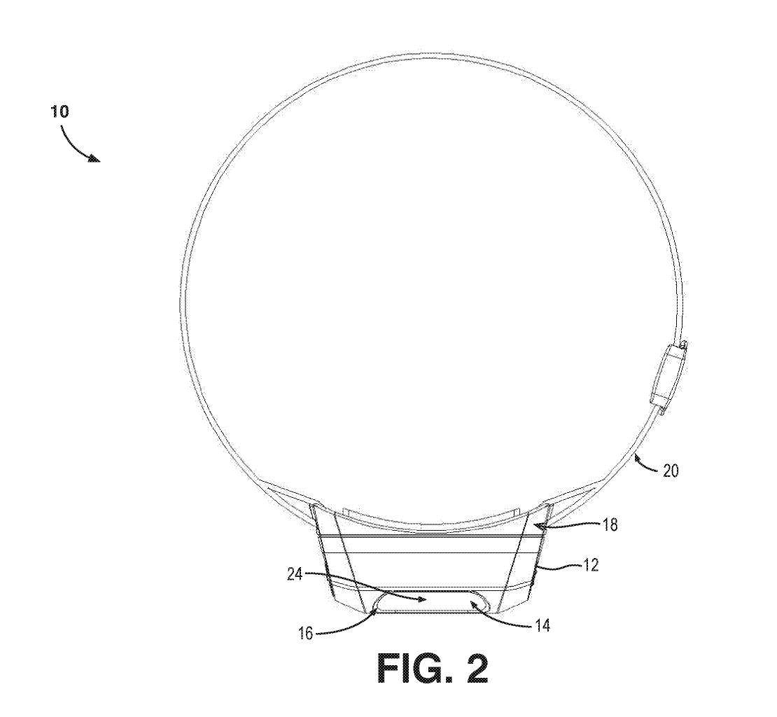

Referring to FIGS. 2-5, the lighting unit 14 includes a light source 24. The light source 24 may comprise one or more LEDs, incandescent bulbs, fluorescent bulbs, halogen bulbs, or the like. In the illustrated embodiment, the light source 24 comprises a high-efficiency, high color rendition index chip-on-board LED. The lighting unit 14 may further include a reflecting unit 26, so that the head lamp 10 can be easily found in the dark. The reflecting unit 26 comprises a reflector 28 and a fluorescer 30.

In this disclosure, the bracket 18 of the head lamp 10 is releasably coupled to the housing 12 so that the housing 12 may be detached from the bracket 18. It will be appreciated that the bracket 18 may be releasably coupled to the housing 12 in any suitable manner. As shown in FIG. 6B, the bracket 18 may include a pair of magnets 32, 33 that correspond with the pair of magnets 22, 23 on the housing 12. It will be understood that the size, number, and/or location of the pair of magnets 32, 33 may vary as necessary or desired.

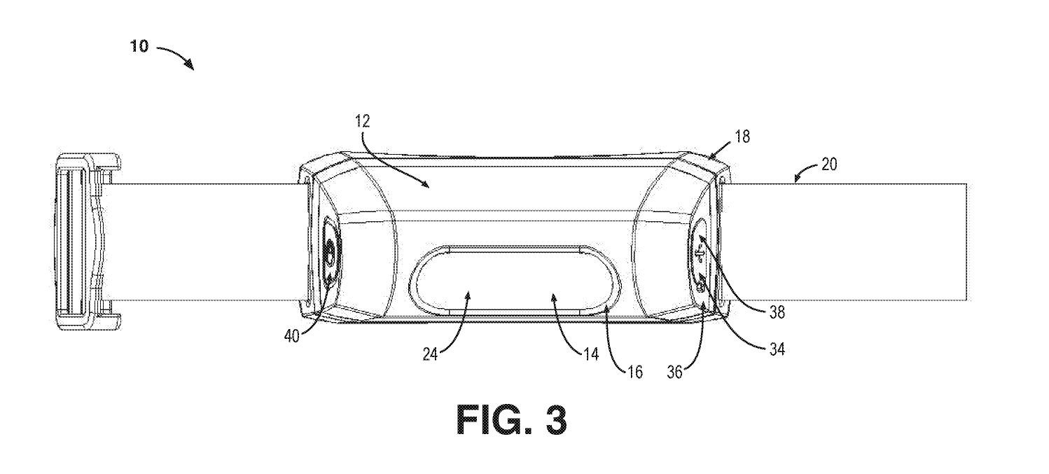

The head lamp 10 may also include an internal power supply (not shown), such as a rechargeable lithium-ion battery, so that the head lamp 10 may be operated even when disconnected from an external power source (not shown), such as a standard electrical outlet. As shown in FIGS. 3-4, 6A, and 7, to facilitate charging of the internal power supply, an external charging socket 34 may be provided on an exterior surface 36 of the housing 12. It will be understood that the size, shape, and location of the external charging socket 34 may vary as necessary or desired. The external charging socket 34 may include a protection cap 38 for protecting the external charging socket 34 from damage. The external charging socket 34 is configured to receive a first end of a cable (not shown). The cable may be any type of cable suitable for transferring an electrical signal, such as a Universal Serial Bus (USB) cable or the like. The cable may be selectively connected to the external power source at a second end of the cable. The head lamp 10 may be additionally provided with a charging indicator (not shown) for indicating the amount of charge left in the internal power supply.

In one mode of operation, when the first end of the cable is connected to the external charging socket 34, and the second end of the cable is connected to the external power source, the internal power supply is charged by the external power source. When the internal power supply is charged, the cable may be disconnected from the external charging socket 34, and the head lamp 10 may be operated without being connected to the external power source by drawing power from the internal power supply.

With reference to FIGS. 3, 5, and 8, the head lamp 10 may additionally include a power button 40 positioned on the exterior surface 36 of the housing 12 for turning on and turning off the light source 24. It will be understood that the size, shape, and location of the power button 40 may vary as necessary or desired.

With further reference to FIGS. 6A and 6B, the bracket 18 may additionally include a connection component 42 configured to be received in a recess 44 formed in the housing 12 to help connect and secure the housing 12 to the bracket 18. In one embodiment of the present invention, the connection component 42 is a screw-type connector, such that when the connection component 42 is inserted into the recess 44, the housing 12 may be rotated with respect to the bracket 18 so that the connection component 42 is secured within the recess 44. As will be appreciated by one of ordinary skill in the art, the configuration of the connection component 42 and/or recess 44 may vary as necessary or desired. The bracket 18 may further include a pair of snap members 46, 47 configured to be received in a corresponding pair of recesses 48, 49 formed in the housing 12. When the housing 12 is connected to the bracket 18, the pair of snap members 46, 47 snap into the corresponding pair of recesses 48, 49 to help align the housing 12 with respect to the bracket 18.

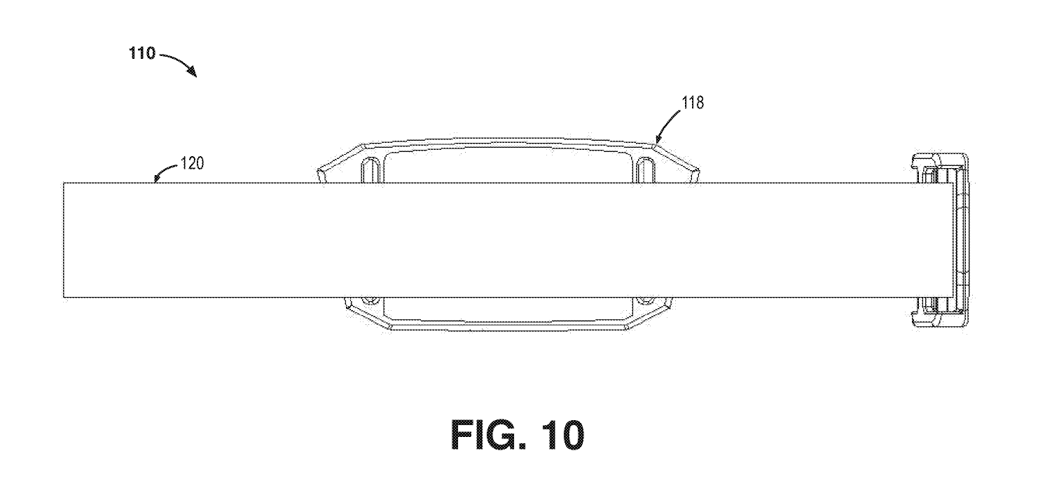

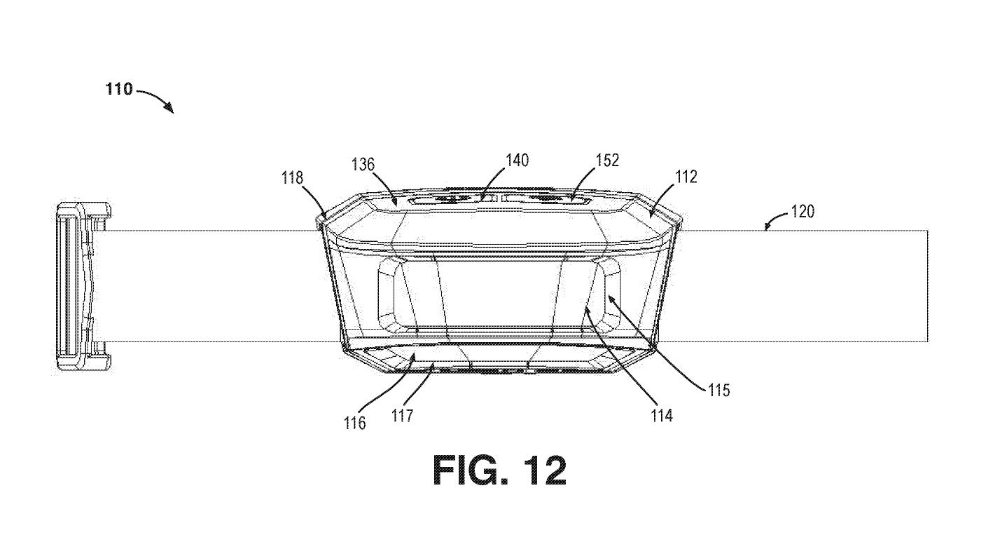

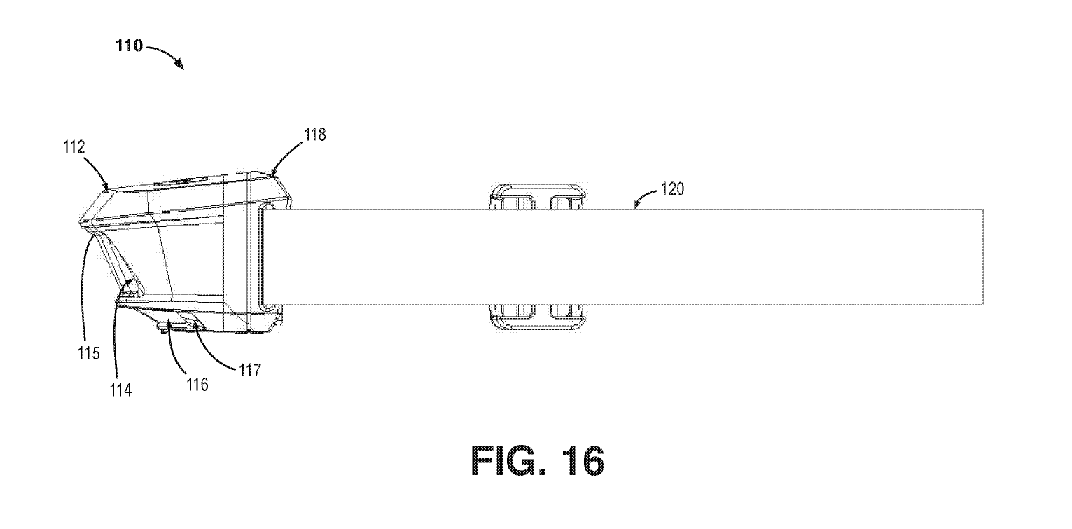

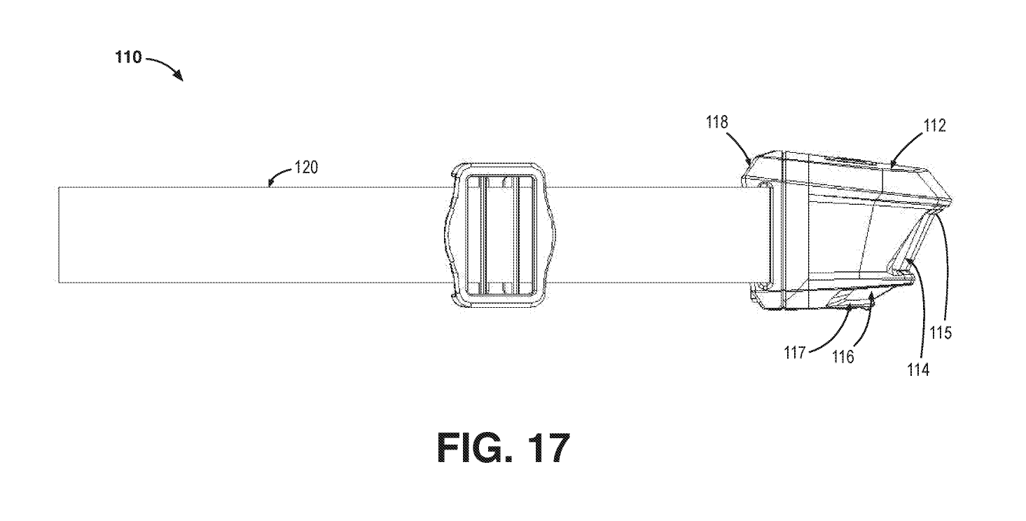

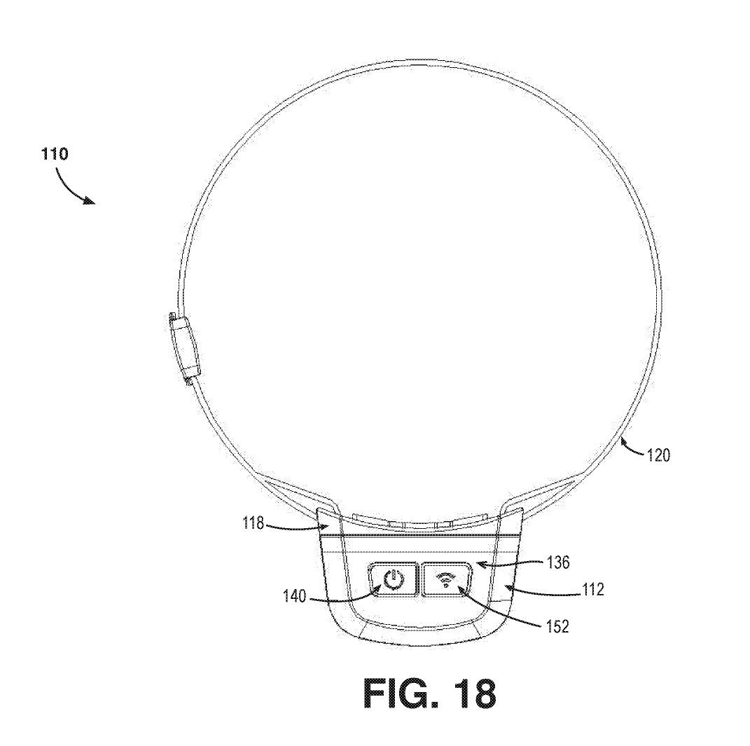

Referring now to FIGS. 10-18, there is illustrated a second example head lamp 110 in accordance with the teachings of the present disclosure. The example head lamp 110 comprises a housing 112, a first lighting unit 114 received in a first opening 115 of the housing 112, a second lighting unit 116 received in a second opening 117 of the housing 112, a bracket 118 releasably coupled to the housing 112, and a head band 120 connected to the bracket 118.

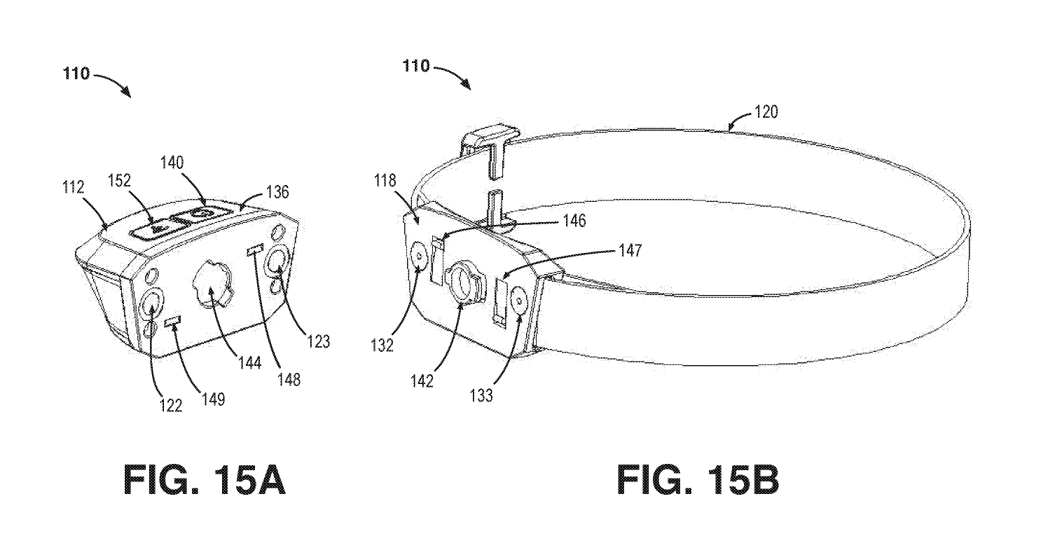

The example head lamp 110 may be configured for both indoor and outdoor uses. Thus, the housing 112 may be formed to provide the head lamp 110 with impact resistance, water resistance, and/or dust resistance. As will be appreciated by one of ordinary skill in the art, the example housing 112 may be formed with any suitable material, such as for instance, aluminum, plastic, carbon fiber, etc. As shown in FIG. 15A, the housing 112 may include a pair of magnets 122, 123, so as to allow the housing 112 to be magnetically coupled to a metal surface, such as the hood of a car. It will be understood that the size, number, and/or location of the pair of magnets 122, 123 may vary as necessary or desired.

The head band 120 is configured to be worn around a user's head. The head band 120 is configured to be adjustable so that the user may adjust the circumference of the head band 120 to fit as desired.

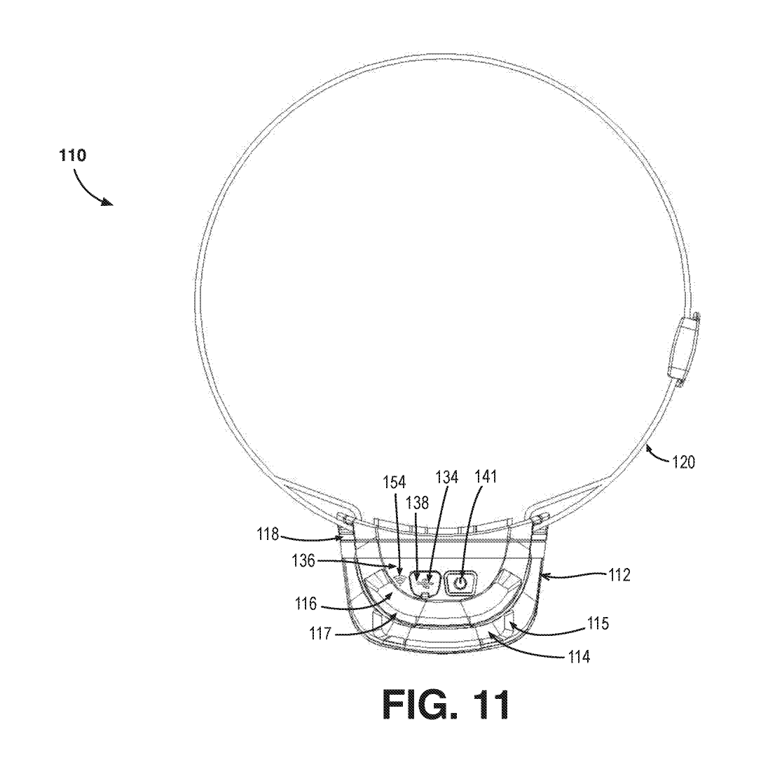

Referring to FIGS. 11-14 and 16-17, the first lighting unit 114 may include a first light source 124, a second light source 125, and a third light source 126. The first light source 124, the second light source 125, and the third light source 126 may each comprise one or more LEDs, incandescent bulbs, fluorescent bulbs, halogen bulbs, or the like. In the illustrated embodiment, the first light source 124 comprises a high power surface-mount device (SMD) LED, while the second light source 125 and the third light source 126 each comprises a high-efficiency, high color rendition index chip-on-board LED. In one embodiment of the present invention, the first light source 124 may function as a spotlight, while the second light source 125 and the third light source 126 may function as flood lights. Further, in some embodiments of the present invention, the first light source 124, the second light source 125, and the third light source 126 may be arranged such that when the first light source 124, the second light source 125, and the third light source 126 are illuminated, the first light source 124, the second light source 125, and the third light source 126 will not cast a shadow on an illuminated surface. It will be understood that the number, type, and/or location of the light sources in the first lighting unit 114 may vary as necessary or desired. The first lighting unit 114 may further include a reflecting unit 127, so that the head lamp 110 can be easily found in the dark. The reflecting unit 127 comprises a reflector 128 and a fluorescer 129.

Referring now to FIGS. 11-12, 14, and 16-17, the second lighting unit 116 includes a light source 130. The light source 130 may comprise one or more LEDs, incandescent bulbs, fluorescent bulbs, halogen bulbs, or the like. In the illustrated embodiment, the light source 130 comprises an arc-shaped, high-efficiency, high color rendition index chip-on-board LED. As further shown in the illustrated embodiment, the light source 130 may be angled downwards so as to illuminate a walking area directly in front of the user's feet. It will be understood that the size, shape, type, and/or location of the light source 130 may vary as necessary or desired.

In this disclosure, the bracket 118 of the head lamp 110 is releasably coupled to the housing 112 so that the housing 112 may be detached from the bracket 118. It will be appreciated that the bracket 118 may be releasably coupled to the housing 112 in any suitable manner. As shown in FIG. 15B, the bracket 118 may include a pair of magnets 132, 133 that correspond with the pair of magnets 122, 123 on the housing 112. It will be understood that the size, number, and/or location of the pair of magnets 132, 133 may vary as necessary or desired.

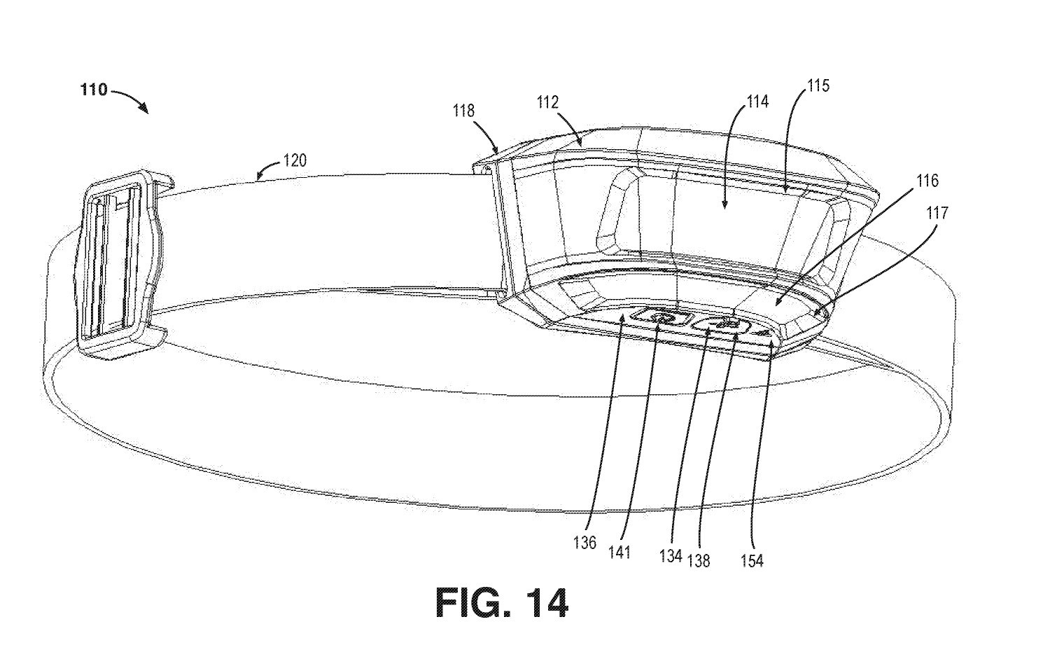

The head lamp 110 may also include an internal power supply (not shown), such as a rechargeable lithium-ion battery, so that the head lamp 110 may be operated even when disconnected from an external power source (not shown), such as a standard electrical outlet. As shown in FIGS. 11 and 14, to facilitate charging of the internal power supply, an external charging socket 134 may be provided on an exterior surface 136 of the housing 112. It will be understood that the size, shape, and location of the external charging socket 134 may vary as necessary or desired. The external charging socket 134 may include a protection cap 138 for protecting the external charging socket 134 from damage. The external charging socket 134 is configured to receive a first end of a cable (not shown). The cable may be any type of cable suitable for transferring an electrical signal, such as a Universal Serial Bus (USB) cable or the like. The cable may be selectively connected to the external power source at a second end of the cable. The head lamp 110 may be additionally provided with a charging indicator (not shown) for indicating the amount of charge left in the internal power supply.

In one mode of operation, when the first end of the cable is connected to the external charging socket 134, and the second end of the cable is connected to the external power source, the internal power supply is charged by the external power source. When the internal power supply is charged, the cable may be disconnected from the external charging socket 134, and the head lamp 110 may be operated without being connected to the external power source by drawing power from the internal power supply.

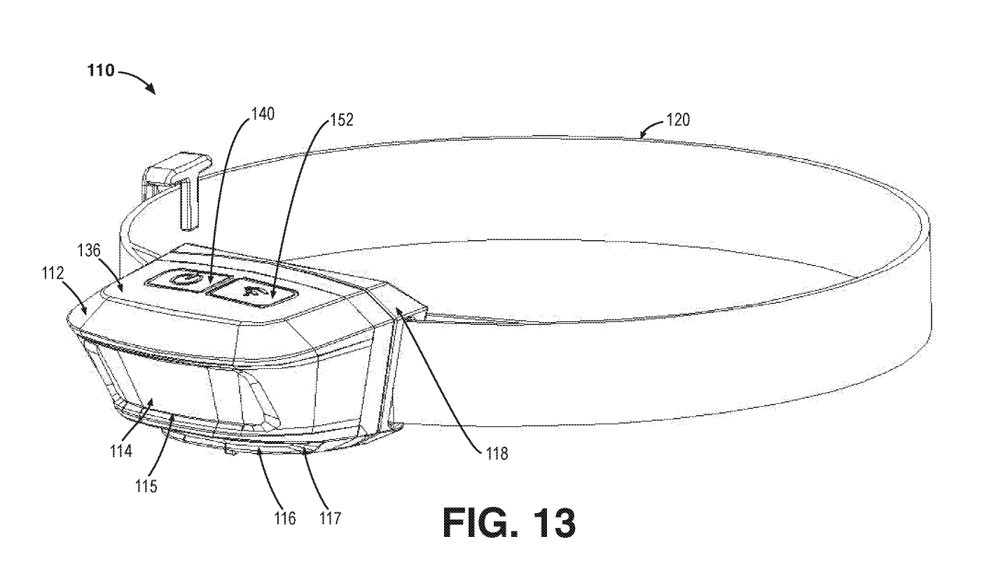

With reference to FIGS. 13, 15A, and 18, the head lamp 110 may additionally include a first power button 140 positioned on the exterior surface 136 of the housing 112 for turning on and turning off the first light source 124, the second light source 125, and/or the third light source 126. In one embodiment of the present invention, the first light source 124 may be turned on and off independently from the second light source 125 and the third light source 126 by, for example, pressing the first power button 140 multiple times. It will be understood that the size, shape, and location of the first power button 140 may vary as necessary or desired.

With reference to FIGS. 11 and 14, the head lamp 110 may also include a second power button 141 positioned on the exterior surface 136 of the housing 112 for turning on and turning off the light source 130. It will be understood that the size, shape, and location of the second power button 141 may vary as necessary or desired.

With further reference to FIGS. 15A and 15B, the bracket 118 may additionally include a connection component 142 configured to be received in a recess 144 formed in the housing 112 to help connect and secure the housing 112 to the bracket 118. In one embodiment of the present invention, the connection component 142 is a screw-type connector, such that when the connection component 142 is inserted into the recess 144, the housing 112 may be rotated with respect to the bracket 118 so that the connection component 142 is secured within the recess 144. As will be appreciated by one of ordinary skill in the art, the configuration of the connection component 142 and/or recess 144 may vary as necessary or desired. The bracket 118 may further include a pair of snap members 146, 147 configured to be received in a corresponding pair of recesses 148, 149 formed in the housing 112. When the housing 112 is connected to the bracket 118, the pair of snap members 146, 147 snap into the corresponding pair of recesses 148, 149 to help align the housing 112 with respect to the bracket 118.

The head lamp 110 may further include a pair of sensor transceivers 150, 151 positioned in the first lighting unit 114. The pair of sensor transceivers 150, 151 are configured to turn on and turn off the first light source 124, the second light source 125, and/or the third light source 126 when an object, such as the user's hand (not shown), is waved in front of the pair of sensor transceivers 150, 151. It will be understood that the number and location of the pair of sensor transceivers 150, 151 may vary as necessary or desired. It will be further understood that the pair of sensor transceivers 150, 151 may control the first light source 124, the second light source 125, and/or the third light source 126 independently or as a group, as necessary or desired.

As shown in FIGS. 13, 15A, and 18, the head lamp 110 may additionally include a sensor switch 152 provided on the exterior surface 136 of the housing 112 for activating and inactivating the pair of sensor transceivers 150, 151. It will be understood that the size, shape, and location of the sensor switch 152 may vary as necessary or desired.

As shown in FIGS. 11 and 14, the head lamp 110 may additionally include a sensor indicator 154 provided on the exterior surface 136 of the housing 112 for indicating whether the pair of sensor transceivers 150, 151 are activated or inactivated. It will be understood that the size, shape, and location of the sensor indicator 154 may vary as necessary or desired.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

What is claimed is:

1. A head lamp comprising:
a housing;
at least one light source affixed to a surface of the housing and operable to emit light;
a reflecting unit affixed to the surface of the housing, the reflecting unit comprising a reflector and a fluorescer;
a power source operable to power the at least one light source;
a bracket releasably coupled to the housing; and
a head band connected to the bracket.

2. The head lamp of claim 1, wherein the power source comprises a battery.

3. The head lamp of claim 2, wherein the battery is rechargeable by an external A/C or D/C power source.

4. The head lamp of claim 3, further comprising an external charging socket affixed to the surface of the housing.

5. The head lamp of claim 1, wherein the at least one light source comprises one or more LEDs.

6. The head lamp of claim 1, further comprising a power button operable to turn on and turn off the at least one light source.

7. The head lamp of claim 1, further comprising at least one magnet affixed to the surface of the housing.

8. The head lamp of claim 7, further comprising at least one magnet affixed to a surface of the bracket.

9. The head lamp of claim 1, further comprising a connection component affixed to a surface of the bracket and a recess formed in the housing, wherein the connection component is configured to be received in the recess when the bracket is coupled to the housing.

10. A head lamp comprising:
a housing;
a first lighting unit affixed to a surface of the housing, the first lighting unit including at least one light source operable to emit light;
a second lighting unit affixed to the surface of the housing, the second lighting unit comprising a second light source operable to emit light;
a reflecting unit affixed to the surface of the housing, the reflecting unit comprising a reflector and a fluorescer;
a power source operable to power the at least one light source and the second light source;
a bracket releasably coupled to the housing; and
a head band connected to the bracket.

11. The head lamp of claim 10, wherein the power source comprises a battery.

12. The head lamp of claim 11, wherein the battery is rechargeable by an external A/C or D/C power source.

13. The head lamp of claim 12, further comprising an external charging socket affixed to the surface of the housing.

14. The head lamp of claim 10, wherein the at least one light source comprises one or more LEDs.

15. The head lamp of claim 14, wherein at least one of the LEDs emits light forward for a distance of at least 1 meter from the at least one light source.

16. The head lamp of claim 15, wherein the second light source emits ambient light to an area immediately in front of the second light source.

17. The head lamp of claim 10, further comprising a pair of sensor transceivers operable to turn on and turn off the at least one light source.

18. The head lamp of claim 17, further comprising a sensor switch for activating and inactivating the pair of sensor transceivers.

19. The head lamp of claim 10, further comprising a first power button operable to turn on and turn off the at least one light source.

20. The head lamp of claim 10, further comprising a second power button operable to turn on and turn off the second light source.

21. The head lamp of claim 10, further comprising at least one magnet affixed to the surface of the housing.

22. The head lamp of claim 21, further comprising at least one magnet affixed to a surface of the bracket.

23. The head lamp of claim 10, further comprising a connection component affixed to a surface of the bracket and a recess formed in the housing, wherein the connection component is configured to be received in the recess when the bracket is coupled to the housing.
